(19) United States
(12) Patent Application Publication
(10) Pub. No.: US 2025/0213411 A1
(43) Pub. Date: Jul. 3, 2025

(54) SYSTEMS AND METHODS FOR NEONATAL CARE WITH A MODULATING HEATING COMPONENT

(71) Applicant: GE Precision Healthcare LLC, Waukesha, WI (US)

(72) Inventors: Rajendra Naik, Bangalore (IN); Ramune Auzelyte, Milwaukee, WI (US); Steven M. Falk, Baltimore, MD (US); Daniel Garcia, Pewaukee, WI (US)

(21) Appl. No.: 18/401,079

(22) Filed: Dec. 29, 2023

(51) Int. Cl. A61G 11/00

(52) U.S. Cl. CPC A61G 11/00; A61G 2210/90

(57) ABSTRACT

A neonate care station is described herein that includes a support platform for housing a neonate and a modulating heater. The modulating heater can include a heater element coupled to a first reflective dish, wherein the heater element and the first reflective dish are configured to modulate to provide thermally conditioned air to the support platform using a convective heating technique in an incubator setting or radiant heat using a radiant heating technique in a radiant heating setting.

### FIELD

Techniques disclosed herein relate to a neonate care station, and more particularly to heating a neonate care station with a modulating heater.

### BACKGROUND

In some cases, neonate patients are not physiologically well enough developed to be able to survive without special medical attention. A medical aid that is frequently used for such neonates is the incubator. One objective of the incubator is to provide an environment which will maintain the neonate at a minimum metabolic state thereby permitting rapid physiological development. Neonatal incubators create a microenvironment that is thermally neutral where a neonate can develop. These incubators typically include a humidifier and a heater and associated control system that controls the humidity and temperature in the neonatal microenvironment. The humidifier comprises a device that evaporates an evaporant, such as distilled water, to increase relative humidity of air within the neonatal microenvironment. The humidifier is typically controllable such that the amount of water, or water vapor, added to the microenvironment is adjustable in order to control the humidity to a desired value. The heater may be, for example, an air heater controllable to maintain the microenvironment area to a certain temperature. In some examples, radiant warmers may be used instead of incubators for some neonates where less environmental control is required. In still other embodiments, hybrid incubator/radiant warming systems may be utilized.

Since the microenvironment is accurately controlled in a neonatal or neonate care station, the neonate care station includes an enclosure that is sealed to help maintain the controlled microenvironment. Such an enclosure will typically include four sidewalls or side panels and a top hood or canopy that surround a neonate support platform.

Neonate care stations can use any number of heaters to provide radiant heat or thermally conditioned air to a neonate residing on a neonate support platform such as a mattress or a bed of the neonate care station. In some examples described herein, a neonate care station can include at least one heater that can be modulated to provide radiant heat or thermally conditioned air to a neonate care station from one or more directions.

### BRIEF DESCRIPTION

This section is provided to introduce a selection of concepts that are further described below in the Detailed Description. This Brief Description is not intended to identify key or essential features of the claimed subject matter, nor is it intended to be used as an aid in limiting the scope of the claimed subject matter.

In one example, a neonate care station can include a support platform for housing a neonate and a modulating heater that can include a heater element coupled to a first reflective dish, wherein the heater element and the first reflective dish are configured to modulate to provide thermally conditioned air to the support platform using a convective heating technique in an incubator setting or radiant heat using a radiant heating technique in a radiant heating setting. Thermally conditioned air, as referred to herein, can include air that is altered to a predetermined temperature, humidity, or the like. Radiant heat, as referred to herein, can include any suitable source of thermal radiation directed toward a surface which results in warming of said surface to a predetermined temperature.

In another example, a method for operating a neonate care station can include detecting an incubator setting for the neonate care station and providing, using a modulating heater, thermally conditioned air to a support platform of the neonate care station. The method can also include detecting a reconfiguration of the neonate care station from an incubator with a closed canopy to a neonate warmer with an open canopy and repositioning the modulating heater to provide radiant heat towards a top of the neonate care station. Furthermore, the method can include providing the radiant heat to the support platform of the neonate care station using the modulating heater and an overhead reflective dish.

In yet another example, a method for operating a neonate care station can include detecting a warmer setting for the neonate care station and providing, using the modulating heater, radiant heat to a support platform of the neonate care station. The method can also include detecting a reconfiguration of the neonate care station from a neonate warmer with an open canopy to an incubator with a closed canopy and repositioning the modulating heater to provide thermally conditioned air towards a bottom of the neonate care station or along the canopy and the sidewalls. Furthermore, the method can include providing the thermally conditioned air to the support platform of the neonate care station using the modulating heater to support a convective heating of a microenvironment of the neonate care station.

Various other features, objects, and advantages of the invention will be made apparent from the following description taken together with the drawings.

### BRIEF DESCRIPTION OF THE DRAWINGS

The present disclosure will be better understood from reading the following description of non-limiting examples, with reference to the attached drawings broadly described below:

FIG. 1 is a perspective view of an example neonate care station operating as an incubator without a modulating heater;

FIG. 2 is a perspective view of an example neonate care station operating as a neonate warmer without a modulating heater;

FIG. 3 is an example of a neonate care station using a modulating heater to provide convective heat in an incubator setting in accordance with one example;

FIG. 4 is an example neonate care station using a modulating heater to provide radiant heat in a neonate warmer setting in accordance with one example;

FIG. 5 provides an example process flow diagram for operating a neonate care station with a modulating heater in accordance with one example;

FIG. 6 illustrates an example neonate care station with a modulating heater to provide radiant heat in a neonate warmer setting or convective heating in an incubator setting in accordance with one example;

FIG. 7 is an example process flow diagram for operating a neonate care station with a modulating heater coupled to a canopy, in accordance with one example;

FIG. 8 is an example neonate care station that provides thermally conditioned air along a canopy or a wall of the neonate care station, in accordance with one example;

FIG. 9 illustrates an example computing device for warming a neonate care station with a modulating heater in accordance with one example;

FIG. 10 illustrates computer-readable storage media that can operate a neonate care station with a modulating heater; and

FIG. 11 is an example process flow diagram for operating a neonate care station without a heat sink.

The drawings illustrate specific aspects of the described components, systems and methods for providing a neonatal incubator system. Together with the following description, the drawings demonstrate and explain the principles of the structures, methods, and principles described herein. In the drawings, the thickness and size of components may be exaggerated or otherwise modified for clarity. Well-known structures, materials, or operations are not shown or described in detail to avoid obscuring aspects of the described components, systems and methods.

### DETAILED DESCRIPTION

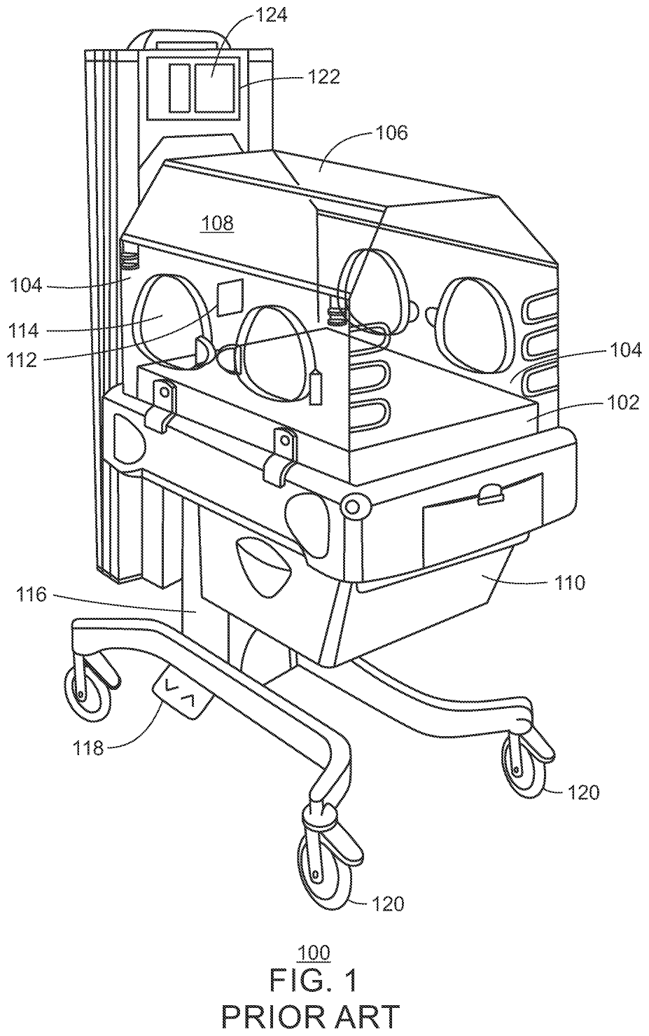

Embodiments of the present disclosure will now be described, by way of example, with reference to FIGS. 1-11, in which the following description relates to various examples of neonate care stations. The following description relates to various techniques, methods, non-transitory computer-readable media, and systems for heating a neonate care station with one or more modulating heaters.

In some neonate care stations, multiple heaters can be used to provide radiant warming and convective heating to a neonate patient. For example, a first heater can be located in a static location for providing thermally conditioned air to a neonate care station using convective heating techniques for an incubator. In other examples, a second heater can be located at a different static location for providing radiant heat to a neonate care station using radiant heating techniques for a neonate warming station.

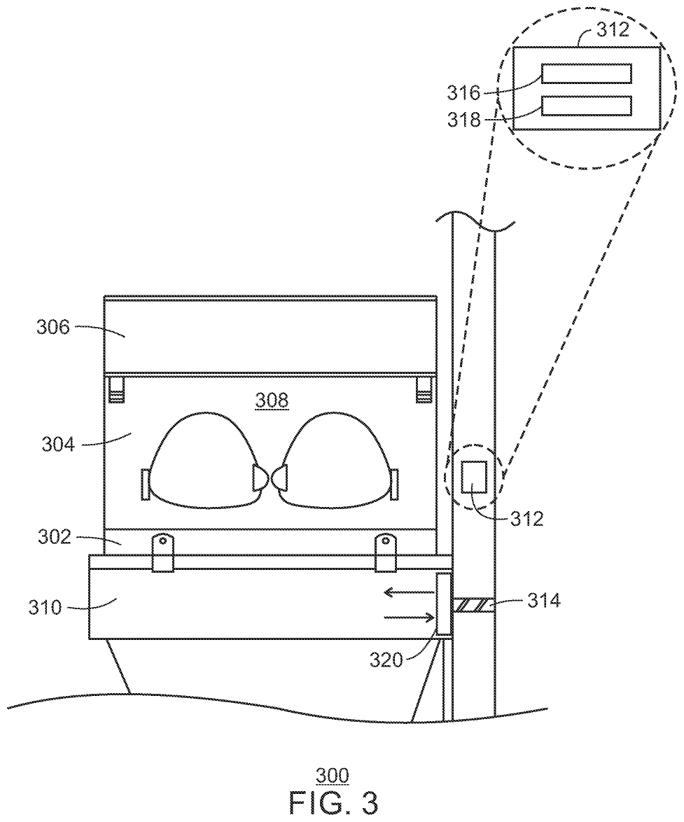

Techniques herein have the technical advantage of using one or more modulating heaters that can modulate to provide radiant heat or thermally conditioned air to a neonate patient. The modulating heaters, as referred to herein, can modulate, rotate, swivel, or otherwise move from a first configuration providing convective heating to a neonate care station to a second configuration providing radiant warming to a neonate care station. In some examples, a technical effect or advantage of using a modulating heater to operate a neonate care station can include avoiding a pre-warming of the heater and reducing cycling of the multiple heaters of previous neonate care stations, which can degrade the heaters. The techniques herein that utilize a modulating heater to provide radiant heating and convective heating can also enable a modification to the neonate care station to place the modulating heater in various locations that are removed from the neonate patient. For example, the modulating heater can be located behind a housing along a perimeter of a support platform of a neonate care station, which can enable additional technical advantages as described in greater detail below in relation to FIGS. 3-11.

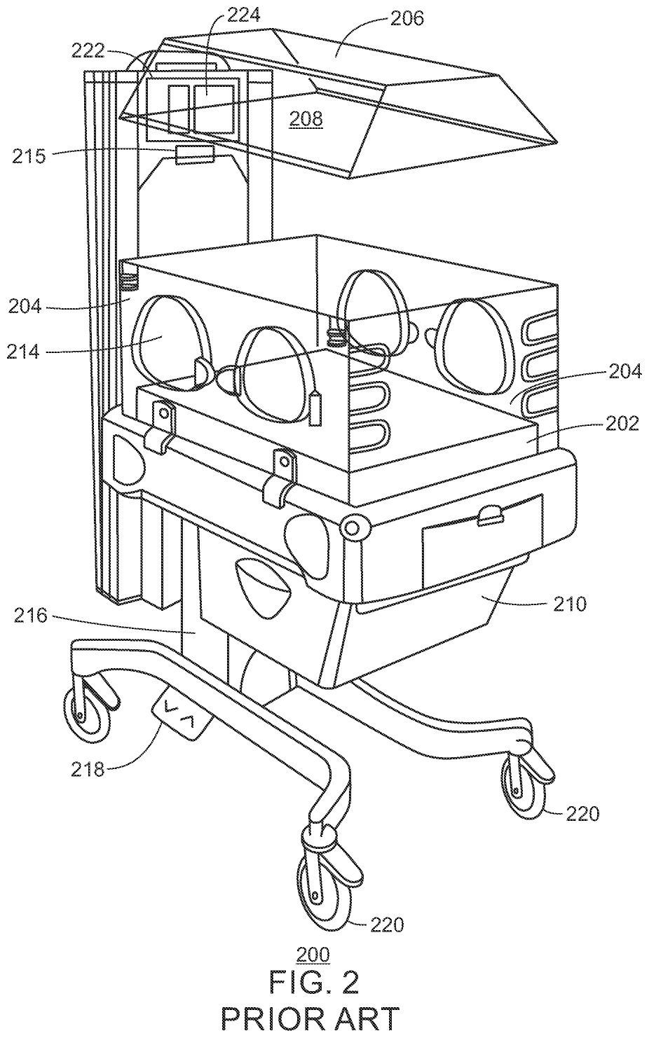

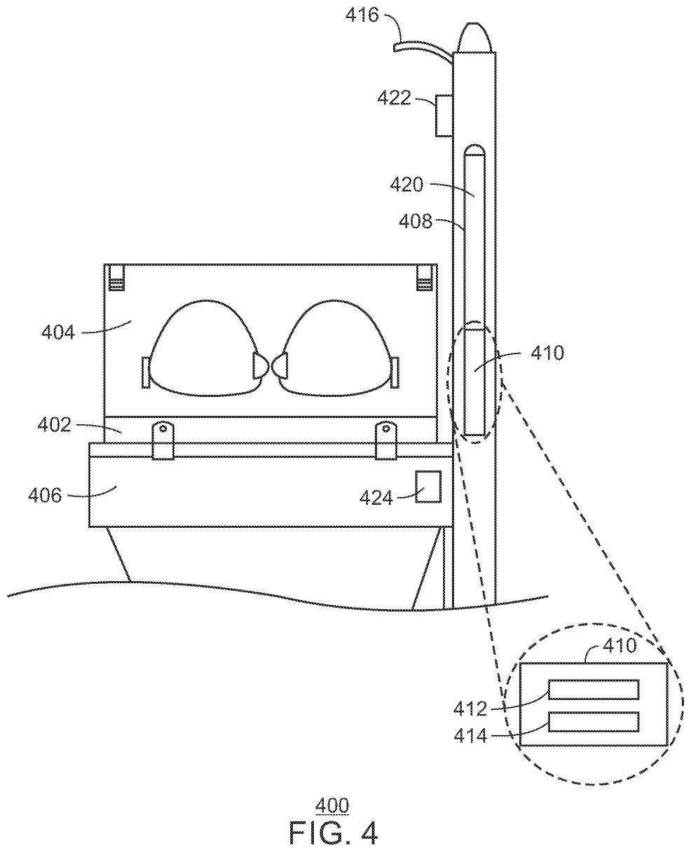

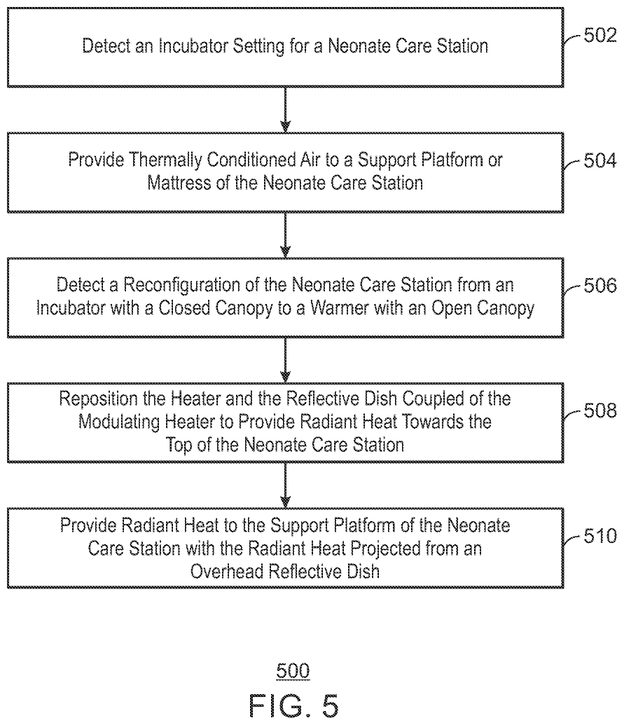

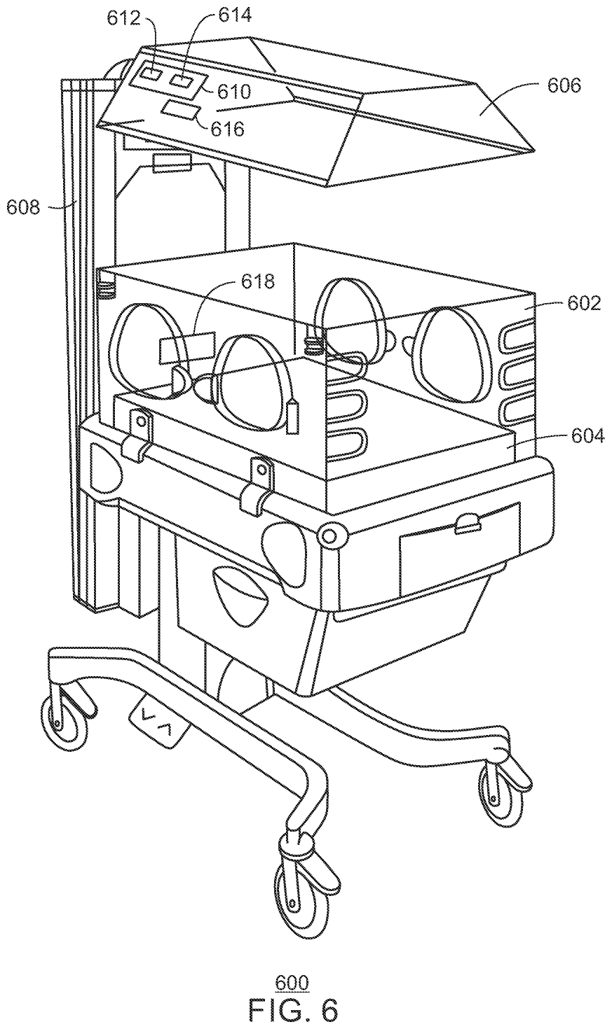

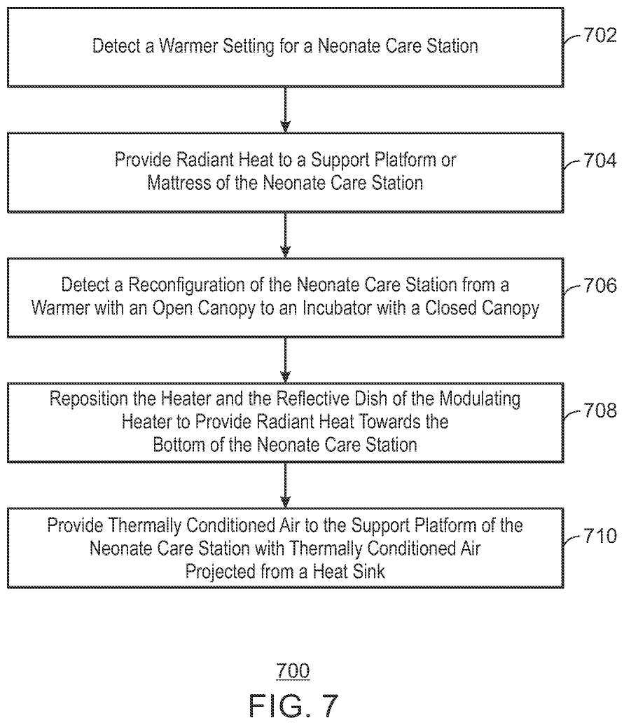

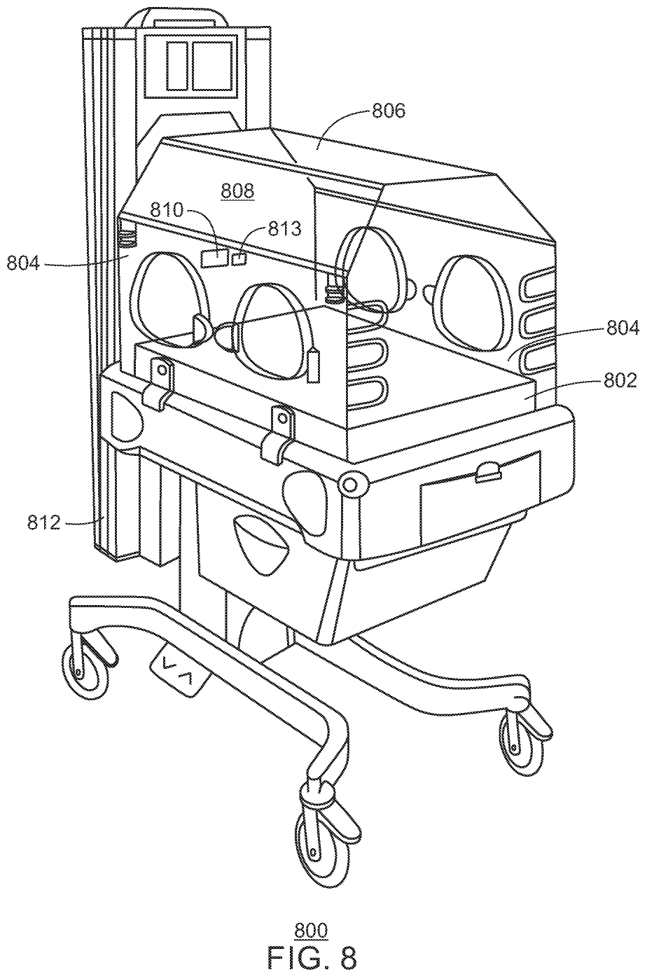

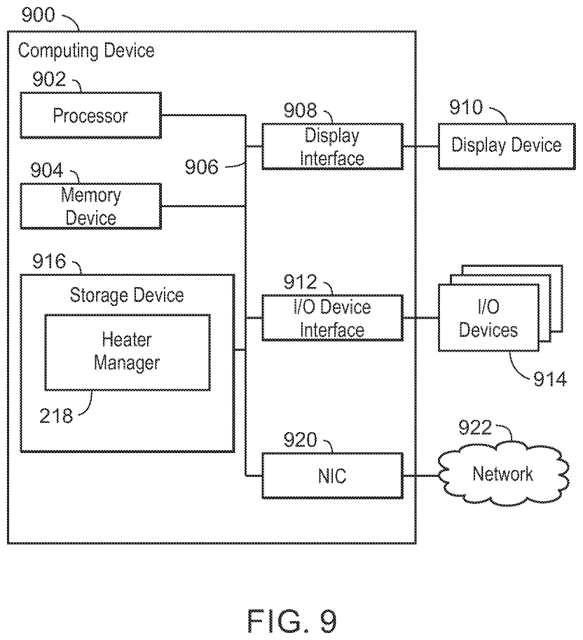

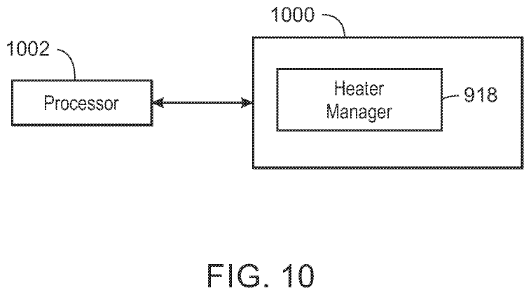

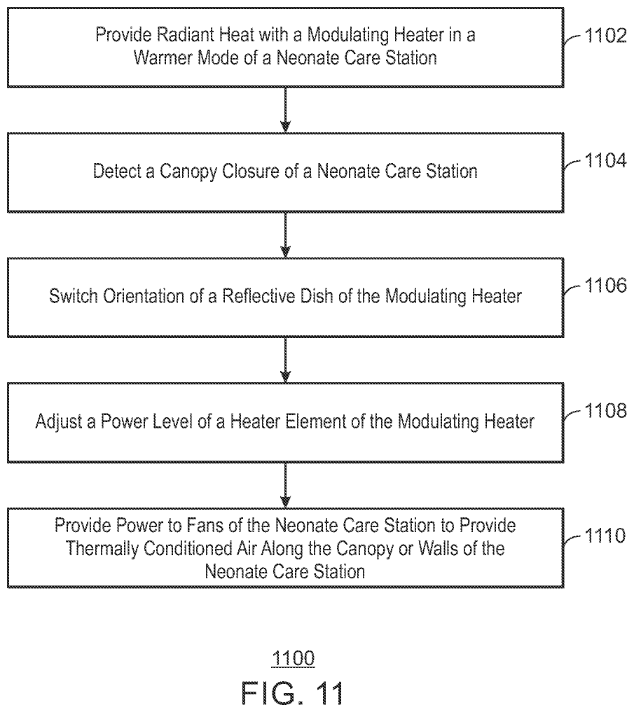

FIGS. 1 and 2 provide example embodiments of previous neonate care stations configured to operate as an incubator and a neonate warmer respectively using multiple heaters that are not configured to modulate or move. FIG. 3 is an example of a neonate care station using a modulating heater to provide convective heat in an incubator setting. FIG. 4 is an example neonate care station using a modulating heater to provide radiant heat in a neonate warmer setting. FIG. 5 provides an example process flow diagram for operating a neonate care station with a modulating heater. FIG. 6 illustrates an example neonate care station with a modulating heater to provide radiant heat in a neonate warmer setting or convective heating in an incubator setting. FIG. 7 is an example process flow diagram for operating a neonate care station with a modulating heater. FIG. 8 is an example neonate care station that provides thermally conditioned air along a canopy. FIGS. 9 and 10 provide example computing devices and computer-readable storage media, respectively, that can operate a neonate care station with a modulating heater. FIG. 11 is an example process flow diagram for operating a neonate care station without a heat sink.

FIG. 1 is a perspective view of an example neonate care station operating as an incubator without a modulating heater. In the example of FIG. 1, a neonate care station is depicted in which the neonate care station is an incubator 100. The incubator 100 includes a horizontal surface 102 that is configured to support a neonate patient (not depicted). It is to be understood that the incubator 100 may have the ability or control to modulate, move, rotate, or incline the horizontal surface 102; however, it will be understood that the horizontal surface 102 will generally remain horizontal such as to minimize movement of the neonate patient within the incubator 100 due to gravity.

One or more walls 104 extend generally vertically from the horizontal surface 102. In the embodiment depicted in FIG. 1 of the incubator 100, four walls extend vertically from the horizontal surface 102 to define the rectangular shape of the incubator 100. However, it will be understood that in alternative examples, various numbers of walls 104 may be used to define the incubator into various geometric shapes which may include, but are not limited to, circles or hexagons. The incubator 100 can further include a canopy 106 that extends over the horizontal surface 102. In some examples, the canopy 106 can include multiple components or surfaces, or the canopy may be curved or domed in shape.

While the incubator of FIG. 1 is depicted with the horizontal surface 102, walls 104, and canopy 106 being connected, it will be understood that in alternative examples, including those described in greater detail herein, the horizontal surface 102, walls 104, and canopy 106 may be individual components that also may be moveable with respect to each other. For example, the canopy 106 can transition from a closed position to an open position in which any suitable portion of the canopy 106 is raised away from the walls 104 to allow the microenvironment 108 to be exposed to the surrounding environment of the incubator 100.

The horizontal surface 102, walls 104, and canopy 106 can define a microenvironment 108 contained within these structures. In some examples, the incubator 100 is configured such that the microenvironment 108 surrounds the neonate patient (not depicted) such that the neonate patient is only exposed to a controlled combination of environmental characteristics or conditions (temperature, humidity, O2 concentration, etc.) selected by a clinician to promote the health and wellbeing of the neonate patient. In some examples, the walls 104 further include arm portholes 114 that permit a clinician access into the microenvironment 108.

In some examples, the incubator 100 includes a base 110 that houses a convective heater 112. The convective heater 112 is operated such that air is drawn into the incubator 100, at which point the air may be filtered or sterilized in another manner, including the use of UV light before being passed by heating coils (not depicted) to heat the air to a target or set point temperature. The sterilized and heated air is blown into the microenvironment 108 through vents (not depicted) which are arranged along the walls 104. As is also known, the air may be entrained with supplemental gasses such as oxygen or may have added humidity such as to control these conditions within the microenvironment 108. The convective heater 112 is a dedicated heater for providing convective heating without the ability to modulate or provide radiant heating. In some examples, the incubator 100 may include a separate second heater (not depicted) that operates to provide radiant heat to a neonate.

Examples of the incubator 100 further include a pedestal 116 connected to the base 110. The pedestal 116 includes mechanical components (not depicted), which may include, but are not limited to, servo motors, rack and pinion systems, or screw gear mechanisms that are operable by foot pedals 118 to raise or lower the base 110, effectively raising or lowering the position of the neonate patient (not depicted) in relation to the clinician. The incubator 100 may be moveable by wheels or casters 120 connected to the pedestal 116.

The example of the incubator 100 depicted in FIG. 1 includes a graphical display 122 that is mounted to a wall, the base 110, or the canopy 106 of the incubator 100 at a position external to the microenvironment 108. The graphical display 122 is operated by a processor to present a graphical user interface (GUI) 124. In the example illustrated, the graphical display 122 is a touch-sensitive graphical display and the GUI 124 is configured to specifically respond to inputs made by a clinician received through the touch-sensitive graphical display. During normal operation, the touch-sensitive graphical display 122 and touch-sensitive configured GUI 124 are used to control various functions of the incubator 100. The GUI 124 presents a variety of information, such as the air temperature and alarm indications. In some examples, the alarm indications can provide a message indicating an access point is unsealed or open, a change in environment characteristics, or a warning that a heater is still operational after the canopy 106 has been closed, among others.

In some examples, the walls 104 of the incubator 100 can be opened or closed to enable a clinician to access a patient residing in the incubator 100. For example, the walls 104 can serve as doors that open and close to either remove a patient from the incubator 100 or to place a patient into the incubator 100. The walls 104 can include any number of access points, such as portholes 114 covered by porthole doors, that enable access to a patient residing in a microenvironment of the incubator 100.

FIG. 2 is a perspective view of an example neonate care station operating as a neonate warmer without a modulating heater. In some examples, the neonate care station 200 can include a horizontal surface 202, walls 204, and canopy 206 being connected. In some examples, the horizontal surface 202, walls 204, and canopy 206 may be individual components that also may be moveable with respect to each other. For example, the example configuration of FIG. 2 depicts an open canopy 206 raised away from the walls 204 to allow operation as a warmer in which the microenvironment is exposed to the surrounding environment of the neonate care station 200.

The horizontal surface 202, walls 204, and canopy 206 can define a microenvironment 208 that is exposed to ambient air due to the raised canopy 206. In some examples, the walls 204 further include arm portholes 214 that permit a clinician access into the microenvironment 208. In some examples, the walls 204 can be shorter or taller and may not include arm portholes 214 in a warmer configuration.

In some examples, the neonate care station 200 includes a base 210 that supports a support platform 212. The neonate care station 200 can also include a radiant heater 214 above the support platform 212. The radiant heater 214 can be configured to provide radiant heat to the support platform 212 to warm a neonate patient. As discussed in greater detail below in relation to FIGS. 3-10, techniques herein include placing the radiant heater 214 in a different configuration so that the radiant heater 214 is not above the support platform 212. In some examples, the radiant heater 214 can also be repositioned so that a single heater can provide either radiant heat in an open canopy configuration or convective heat in a closed canopy configuration. The radiant heater 214 in FIG. 2 is a dedicated heater for providing radiant heating without the ability to modulate or provide convective heating. In some examples, the neonate care station 200 may include a separate second heater (not depicted) to provide thermally conditioned air in an incubator setting with a closed canopy 206.

Examples of the neonate care station 200 further include a pedestal 216 connected to the base 210. The pedestal 216 includes mechanical components (not depicted), which may include, but are not limited to, servo motors, rack and pinion systems, or screw gear mechanisms that are operable by foot pedals 218 to raise or lower the base 210, effectively raising or lowering the position of the neonate patient (not depicted) in relation to the clinician. The neonate care station 200 may be moveable by wheels or casters 220 connected to the pedestal 216.

The example of the neonate care station 200 depicted in FIG. 2 includes a graphical display 222 that is mounted to a wall, the base 210, or the canopy 206 of the neonate care station 200 at a position external to the microenvironment 208. The graphical display 222 is operated by a processor to present a graphical user interface (GUI) 224. In the example illustrated, the graphical display 222 is a touch-sensitive graphical display and the GUI 224 is configured to specifically respond to inputs made by a clinician received through the touch-sensitive graphical display. During normal operation, the touch-sensitive graphical display 222 and touch-sensitive configured GUI 224 are used to control various functions of the neonate care station 200. The GUI 224 presents a variety of information, such as the air temperature and alarm indications. In some examples, the alarm indications can provide a message indicating a change in environment characteristics, or a warning that a neonate patient is too warm, among others.

FIG. 3 is an example of a neonate care station using a modulating heater to provide convective heat in an incubator setting. In some examples, the neonate care station 300 can include a horizontal surface 302, such as a bed, mattress, or the like, walls 304, and canopy 306 being connected to form microenvironment 308. In some examples, the horizontal surface 302, walls 304, and canopy 306 may be individual components that also may be moveable with respect to each other. For example, the example configuration of FIG. 3 depicts a closed canopy 306 on the walls 304 to allow operation as an incubator which the microenvironment 308 is not exposed to the surrounding environment of the neonate care station 300.

In some examples, the neonate care station 300 includes a base 310 that supports the horizontal surface 302 or bed. The neonate care station 300 can also include a modulating heater 312 proximate to the support platform 302. The modulating heater 312 can be configured to provide thermally conditioned air to the support platform 302 in a uniform manner to physiologically support or warm an infant patient. For example, the modulating heater 312 can be configured to provide radiant heat downward to a heat sink 314. The heat sink 314 can enable thermally conditioned air to be provided to the microenvironment 308 using any suitable number of ducts, channels, or the like that can distribute the thermally conditioned air to any number of areas along the bottom or perimeter of a mattress or support platform 302 of the neonate care station 300, with the aid of one or more fans. In some examples, the modulating heater 312 focused on the heat sink 314 can enable a convective heating setting for the neonate care station 300 in order to provide thermally conditioned air to maintain a predetermined temperature of the microenvironment 308.

In some examples, the modulating heater 314 of the neonate care station 300 can include a heater element 316 and a reflective dish 318 configured to provide thermally conditioned air for the neonate care station 300. The thermally conditioned air can be provided by the neonate care station 300 to the base 310 of the neonate care station 300 as illustrated in FIG. 3 or the modulating heater 314 can modulate or be rotated to provide radiant heat upwards for a radiant heater setting described in relation to FIG. 4 below.

In some examples, any number of fans 320 can be included in the neonate care station 300 to circulate the thermally conditioned air within the microenvironment 308 of the neonate care station 300. For example, any number of fans 320 can circulate the thermally conditioned air from within the microenvironment 308 through any number of openings (not depicted) in a wall, housing, or the like separating the microenvironment 308 from the modulating heater 312.

In some examples, the modulating heater 312 can generate, produce, or otherwise emit radiant heat that can be projected from the heater element 316 onto the reflective dish 318. In some examples, the modulating heater 312 can modulate or rotate the heater element 316, the reflective dish 318 of the modulating heater 312, or a combination thereof in order to direct radiant heat to the heat sink 314.

In some examples, for the incubator setting, the modulating heater 312 may not have rotational capability and could be fixed, focusing the radiant heat onto the heat sink 314. The power level of the modulating heater 312 can be adjusted by any suitable control system for the different modes of operation. In some examples, the modulating heater 312 is configured to modulate so that radiant heat is focused on a heat sink to provide thermally conditioned air to the support platform 302 using a convective heating technique or the modulating heater 312 can provide radiant heat to the support platform 302 using a radiant heating technique. For example, as illustrated in FIG. 4, the modulating heater 312 can be configured to modulate, move, swivel, or rotate to provide radiant heat upwards to enable radiant warming of a neonate.

It is to be understood that the block diagram of FIG. 3 is not intended to indicate that the neonate care station 300 is to include all of the components shown in FIG. 3. Rather, the neonate care station 300 can include fewer or additional components not illustrated in FIG. 3 (e.g., additional walls, porthole access points, display panels, or drawers, etc.).

FIG. 4 is an example neonate care station using a modulating heater to provide radiant heat in a neonate warmer setting in accordance with one example. In some examples, the neonate care station 400 can include a horizontal surface 402 and walls 404. In some examples, the horizontal surface 402 and walls 404 may be individual components that also may be moveable with respect to each other. For example, the example configuration of FIG. 4 depicts an open microenvironment without a canopy above the walls 404 to allow operation as a neonate warmer in which the microenvironment is exposed to the surrounding ambient air and environment of the neonate care station 400.

In some examples, the neonate care station 400 includes a base 406 that supports a horizontal surface or support platform 402. The neonate care station 400 can also include a housing 408 that can include any number of components such as a modulating heater 410 proximate to the support platform 402. The modulating heater 410 can be configured to provide radiant heat to the support platform 402 in a uniform heat pattern, or any other desired pattern to warm a neonate patient. For example, the modulating heater 410 can include a heater element 412 and a first reflective dish 414 that can be configured to provide radiant heat upward to a second overhead reflective dish 416. The reflective dish 416 can enable radiant heat to be provided to a neonate patient on the horizontal surface 402. In some examples, the modulating heater 410 provides radiant heat to the reflective dish 416 or any suitable reflective surface to enable a radiant heating setting for the neonate care station 400 in order to provide radiant heat to maintain a predetermined temperature of the neonate patient.

In some examples, the modulating heater 410 of the neonate care station 400 can include a heater element 412 and a reflective dish 414 configured to provide radiant heat for the neonate care station 400. The radiant heat can be provided by the modulating heater 410 of the neonate care station 400 to provide radiant warming or the modulating heater 410 can modulate, move, swivel, or the like to focus the radiant heat downwards toward a heat sink as in FIG. 3 or the modulating heater 410 can serve as a heat sink as described below in relation to FIGS. 6 and 11.

In some examples, a neonate care station 400 can include a reflective channel 420 or space between the modulating heater 410 and an overhead reflective dish 416. The reflective channel 420 can be any suitable shape or size to enable the radiant heat from a heater element 412 and the reflective dish 414 of the modulating heater 410 to be projected upward to the overhead reflective dish 416. In some examples, the reflective channel 420 can be lined or covered with any suitable material to reflect radiant heat. The reflective channel 420 can be located on an opposing wall 404 of the neonate care station 400. In some examples, the reflective channel 420 resides behind a housing 408 of a neonate care station 400 with a display panel 422. The reflective channel 420 can prevent degradation or any other damage to the display panel 422 from the radiant heat passing proximate to the display panel 422. In some examples, the reflective channel 420 can also include any number of vents or open spaces that may be mechanically or electronically closed or opened to provide a predetermined amount of radiant heat from the heater element 412 and the reflective dish 414 of the modulating heater 410 to the overhead reflective dish 416. In some examples, the reflective dish 416 can be located over a mattress or support platform 402 of the neonate care station 400, over a display panel 422 of a neonate care station 400, behind a display panel 422 of the neonate care station 400, or any other suitable location proximate to the support platform 402 or mattress. In some examples, the reflective dish 416 can be parabolic or any other suitable shape or configuration to transfer radiant heat from the heater element of the modulating heater 410 below to the mattress or support platform 402 of a neonate care station 400.

It is to be understood that the block diagram of FIG. 4 is not intended to indicate that the neonate care station 400 is to include all of the components shown in FIG. 4. Rather, the neonate care station 400 can include fewer or additional components not illustrated in FIG. 4 (e.g., additional walls, porthole access points, display panels, or drawers, etc.). For example, the neonate care station 400 can include any number of modulating heaters 410 that can provide, generate, or otherwise emit radiant heat toward the support platform or horizontal surface 402 of the neonate care station 400. In some examples, two or more modulating heaters 410 can be positioned proximate one another and can simultaneously modulate to provide convective heating for an incubator setting or radiant heating for a neonate warmer setting.

In some examples, one or more modulating heaters 410 can be configured to accept or utilize multiple heater elements 412. For example, a modulating heater 410 may include two or more heater elements 412 that emit or generate radiant heat. In some examples, the heater elements 412 of the modulating heater 410 can be made of the same materials or different materials and the heater elements 412 may be configured to generate the same amount of radiant heat or different amounts of radiant heat.

In some examples, one or more heater elements 412 can be static while any number of additional heater elements 412 may modulate in relation to a reflective dish 414 of the modulating heater 410. For example, the heater elements 412 can be configured to modulate in relation to a reflective dish of the heater 414 to provide heat in an upward direction, a downward direction, or any other suitable direction. In some examples, an angle of the heater elements 412 and the reflective dish 414 can be preconfigured based on a location of the heater elements 412 in relation to the reflective channel 420 of the neonate care station 400. For example, the heater elements 412 can be configured to modulate to a first predetermined location that causes radiant heat to be focused or directed downward to a heat sink 424 located at the base 410 of the neonate care station 400. In some examples, the heater elements 412 can also be configured to modulate to a second predetermined location that causes radiant heat to be focused or directed upward to an overhead reflective dish 416. In some configurations, the radiant heat can be focused or directed from the heater elements 412 at any suitable angle toward the reflective channel 420 to result in the radiant heat propagating or otherwise traveling in the expected direction.

In some examples, the heater element 412 is configured to dynamically reposition to connect to a phase change material proximate to the horizontal support platform 402 or bed. For example, the heater element 412 can focus radiant heat on any suitable substance which releases or absorbs an amount of energy above a threshold level at phase transition to facilitate providing thermally conditioned air. In some examples, the phase change material can include organic, inorganic, hygroscopic, or solid-solid materials. The phase change material can transition between any suitable states of matter such as solid and liquid, among others.

FIG. 5 is a process flow diagram for operating a modulating heater of a neonate care station. In some examples, the method 500 can be implemented with any suitable device such as the neonate care station 300, 400, 600, or 800 of FIGS. 3, 4, 6, and 8 respectively, among others.

At block 502, the method 500 can include detecting an incubator setting for a neonate care station. In some examples, the incubator setting can be detected from a setting in a user interface provided using a display panel. In some examples, the incubator setting can be detected in response to a canopy of a neonate care station being lowered or otherwise placed in a closed microenvironment configuration. As discussed above, the incubator setting can prevent ambient air from entering the microenvironment of the neonate care station.

At block 504, the method 500 can include providing thermally conditioned air to a support platform or mattress of the neonate care station. In some examples, the thermally conditioned air is provided by facing a modulating heater including the heater element and a reflective dish coupled to the heater element in a downward direction so that radiant heat from the heater element and reflective dish is focused on a heat sink that generates the thermally conditioned air. In some examples, the heater element can be configured to face any suitable direction, while the reflective dish coupled to the heater element focuses, reflects, or otherwise projects the radiant heat on a heat sink in the base of the neonate care station. In some examples, the heater element and reflective dish can serve as a heat sink for fans that draw air over the heater element as discussed in greater detail below.

At block 506, the method 500 can include detecting a reconfiguration of the neonate care station from an incubator with a closed canopy to a warmer with an open canopy. In some examples, a configuration can be detected based on whether a canopy is open or closed, a setting from a display panel, or the like. In some examples, the reconfiguration can include transitioning from an incubator setting to a warmer setting or from a warmer setting to an incubator setting. In some examples, a reconfiguration can include any suitable configuration of a neonate care station.

At block 508, the method 500 can include repositioning the heater and the reflective dish coupled to the modulating heater to provide radiant heat towards the top of the neonate care station. For example, the modulating heater including a heater element and a reflective dish can be modulated to provide radiant heat upward rather than downward.

In some examples, the modulating heater can operate at a high temperature to emit radiant heat or near infrared waves. A radiance reflective system or reflective channel can be leveraged to internally direct the near infrared waves or radiant heat from the modulating heater to an overhead reflective surface that can redirect the radiant heat onto the support platform, resulting in a uniform spread of heat or any other desired pattern on the support platform. The reflective channel can be a collinear beam in an enclosed volume, among any other suitable channel for propagating radiant heat. In some examples, the reflective channel can bounce back any radiant heat rays that may be diverging and direct the radiant heat rays to an overhead reflector.

At block 510, the method 500 can include providing radiant heat to the support platform of the neonate care station with the radiant heat projected from an overhead reflective dish. In some examples, the radiant heat is transmitted or projected from the modulating heater, which includes a first reflective dish, to an overhead reflective dish. In some examples, a paraboloid reflector or any other suitable reflective dish can be coupled to the heater element of the modulating heater, which can result in radiant heat being projected to the second overhead reflective dish at the top of the neonate care station.

The process flow diagram of method 500 of FIG. 5 is not intended to indicate that all of the operations of blocks 502-510 of the method 500 are to be included in every example. Additionally, the process flow diagram of method 500 of FIG. 5 describes a possible order of executing operations. However, it is to be understood that the operations of the method 500 can be implemented in various orders or sequences. In addition, in some examples, the method 500 can also include fewer or additional operations.

In some examples, the heater element of the modulating heater is located at a static position proximate to the support platform and configured to modulate or rotate to provide radiant heat upward or downward. In some examples, the heater element of the modulating heater is configured to dynamically reposition to connect to a heat sink proximate to the support platform. In some examples, the heater element of the modulating heater is configured to dynamically reposition to provide radiant heat to a heat sink that results in thermally conditioned air being circulated along a canopy of the neonate care station with any number of fans. In some examples, a double wall reflective channel transfers radiant heat from the heater element to a second reflective dish located above the support platform.

In some examples, one or more fans are located in a canopy of the neonate care station and the one or more fans can circulate thermally conditioned air from the heat sink in response to the canopy being affixed to one or more walls of the neonate care station. In some examples, the heater element and/or reflective dish of a heater can be configured to modulate 180 degrees, or any other number of degrees, from a downward facing position providing radiant heat for convective heating with a heat sink to an upward facing position providing radiant heat to a second reflective dish that distributes the radiant heat to the support platform using a radiant warming technique. In some examples, the heater element and the reflective dish are coupled to a canopy of the neonate care station, and the heater element and the reflective dish are configured to simultaneously modulate from a first position providing radiant heat to a heat sink for convective heating as an incubator when the canopy is closed to a second position providing radiant heat as a warmer when the canopy is open.

In some examples, continuous power is provided to the heater element as the heater element transitions from the first position to the second position. In some examples, a heating output of the heater element is modified as the heater element transitions from the first position to the second position. In some examples, a modulating heater can be coupled or affixed to a canopy of a neonate care station or the modulating heater can move so that the modulating heater is proximate to the canopy as the canopy is raised and lowered. The modulating heater can operate without a heat sink in some examples. For example, any number of fans can be located proximate to the modulating heater to use the heater element and reflective dish of the modulating heater as a heat source. The orientation of the heater element and the reflective dish can be modified as the canopy is raised or lowered. The fans can draw air over or through the modulating heater to heat up the microenvironment of the neonate care station, thus providing thermally conditioned air along a canopy or a wall of the neonate care station.

In some examples, in a radiant mode, the reflective dish of the modulating heater can be pointed towards the support platform or bed to provide a uniform or desired distribution of radiant heat on the support platform. When a canopy of the neonate care station closes, the reflective dish of the modulating heater can be automatically turned, reoriented, or repositioned so that radiant heat is not directed to the support platform. In some examples, in a closed canopy configuration, the reflective dish can modulate, rotate, or flip around to the other side of the heater element of the modulating heater to avoid providing radiant heat rays directly onto the support platform. In some examples, the heater element and reflective dish of the modulating heater can act as a heat sink for providing thermally conditioned air with fans drawing air across or through the modulating heater. In some examples, there is an additional heat sink over which air is forced through by fans to provide the thermally conditioned air in the infant compartment of a neonate care station.

FIG. 6 is a block diagram of a neonate care station with a heater of a neonate care station. The neonate care station 600 can include any suitable number of walls 602, a support platform 604, a canopy 606, a housing 608 to support the canopy 606, and the like. In some examples, the housing 608 can support the canopy 606 as the canopy rises and lowers to enable a radiant warmer setting or an incubator setting of the neonate care station 600.

In some examples, the neonate care station 600 can include a modulating heater 610 that can include any number of heater elements 612 and a reflective dish 614, that can be coupled to the canopy 606 of the neonate care station 600. The modulating heater 610 coupled to the canopy 606 can change positions by travelling up and down vertically as the canopy 606 transitions from an enclosed incubator to a raised warmer in some configurations. Accordingly, the modulating heater 610 may not be located in a static position or location in relation to the support platform 604 of the neonate care station 600. Instead, the modulating heater 610 can dynamically raise and lower in relation to the support platform 604 of the neonate care station 600.

In some examples, fans 616 can be disabled when the canopy 606 is raised or operating with an open microenvironment exposed to ambient air. The fans 616 can be enabled when the canopy 606 is closed or operating as an incubator in which a microenvironment does not include ambient air circulating within the neonate care station 600.

In some examples, the modulating heater 610 is designed to operate with or without a second reflective dish (not depicted) located above the support platform 604. For example, the modulating heater 610 can modulate upward to provide radiant heat to a second reflective dish (not depicted) located above the support platform 604, wherein the second reflective dish reflects radiant heat, or electromagnetic radiation to the support platform 604. In some examples, the modulating heater 610 modulates 610 to a predetermined angle so that the heater 610 directly provides radiant heat, or electromagnetic radiation to the support platform 604 without a second reflective dish. As the canopy 606 transitions to an incubator setting and is lowered, the modulating heater 610 can modulate to any suitable location, rotation, or the like to provide thermally conditioned air using any number of fans that distribute the thermally conditioned air using convective heating techniques to the support platform 604.

In some examples, the modulating heater 610 can include a heater element 612 that is configured to connectively couple with a heat sink 618 through one or more openings of the heat sink 618. For example, the heat sink 618 may include one or more gaps, openings, or the like that enable portions of the heater element 612 to interconnect or otherwise thermally couple the heater element 612 and the heat sink 618. In some examples, the heater element 612 can include fins, protrusions, or the like that are configured to protrude into openings of the heat sink 618 when the heater element 612 is operating in an incubator setting. In some examples, any number of fans can be located proximate to the modulating heater to use the heater element and reflective dish of the modulating heater as a heat source. The fans can draw air over or through the modulating heater to heat up the microenvironment of the neonate care station, thus providing thermally conditioned air in the incubator mode along the canopy 606 or the side walls 602.

It is to be understood that the block diagram of FIG. 6 is not intended to indicate that the neonate care station 600 is to include all of the components shown in FIG. 6. Rather, the neonate care station 600 can include fewer or additional components not illustrated in FIG. 6 (e.g., additional walls, porthole access points, display panels, or drawers, etc.).

FIG. 7 is a process flow diagram for operating a modulating heater of a neonate care station. In some examples, the method 700 can be implemented with any suitable device such as the neonate care station 600 of FIG. 6, among others.

At block 702, the method 700 can include detecting a warmer setting for a neonate care station. In some examples, the warmer setting can be detected from a setting in a user interface provided using a display panel. In some examples, the warmer setting can be detected in response to a canopy of a neonate care station being raised or otherwise placed in an open microenvironment configuration. As discussed above, the warmer setting can allow ambient air from entering the microenvironment of the neonate care station.

At block 704, the method 700 can include providing radiant heat to a support platform or mattress of the neonate care station. In some examples, the radiant heat is provided by automatically modulating or rotating the heater element and a reflective dish coupled to the heater element in an upward direction so that radiant heat from the heater element and the reflective dish is focused on an overhead reflective dish, which focuses the radiant heat to a support platform. In some examples, the heater element can be configured to face any suitable direction, while the reflective dish coupled to the heater element reflects or otherwise projects the radiant heat to the support surface or bed of the neonate care station.

In some examples, the modulating heater can include any number of heater elements that provide radiant heat using an incandescent bulb, among others. In some examples, the heater elements can provide radiant heat or electromagnetic radiation using any suitable shaped incandescent bulb. The radiant heat or electromagnetic radiation can be reflected or projected into one or more directions from the heater element using any suitable reflective dish. The reflective dish can be parabolic, among other shapes or configurations.

In some examples, the modulating heater can provide radiant heat to a support platform of a neonate care station without a separate second reflective dish. For example, the modulating heater can directly provide radiant heat to the support platform. In some examples, the modulating heater can provide radiant heat to a support platform using a second reflective dish coupled to or proximate to the modulating heater. The second reflective dish can be configured to reflect the radiant heat onto the support platform of the neonate care station.

At block 706, the method 700 can include detecting a reconfiguration of the neonate care station from a warmer with an open canopy to an incubator with a closed canopy. In some examples, the canopy is moved from a first open position to a second closed position. The modulating heater can be coupled to the canopy, so that the location of the modulating heater is adjustable as the canopy transitions from the open position to the closed position.

In some examples, a neonate care station can support various techniques for modifying a configuration of the neonate care station to provide radiant heating or convective heating with a heater. For example, the neonate care station can be configured to automatically modulate a heater in response to a change in a canopy position. In some examples, the neonate care station can be configured to mechanically modulate with any suitable rotating mechanism in order to enable a transition from a radiant warmer setting to a convective heating setting. For example, the rotating mechanism can modulate the heater element, reflective dish coupled to the heater element, or any combination thereof. In some examples, the heater element and/or reflective dish can be modulated 180 degrees, or any other amount that enables providing radiant heat downward to a heat sink in the base of the neonate care station for convective heating or providing radiant heat to a support platform of the neonate care station using the modulating heater.

In some examples, a neonate care station can have a user interface that enables detecting user input indicating a rotation of the heater element and/or reflective dish is to be performed in the neonate care station. In some examples, the rotation of the heater and/or reflective dish can occur as a canopy of the neonate care station is raised or lowered.

At block 708, the method 700 can include repositioning the heater and the reflective dish coupled to the heater to provide radiant heat towards the bottom of the neonate care station. For example, the modulating heater can be modulated, rotated, or otherwise positioned to provide radiant heat downward to a heat sink rather than at an angle that distributes radiant heat to the support platform.

At block 710, the method 700 can include providing thermally conditioned air to the support platform of the neonate care station with thermally conditioned air projected from a heat sink and any suitable ducts below or proximate to a support platform of the neonate care station.

The process flow diagram of method 700 of FIG. 7 is not intended to indicate that all of the operations of blocks 702-710 of the method 700 are to be included in every example. Additionally, the process flow diagram of method 700 of FIG. 7 describes a possible order of executing operations. However, it is to be understood that the operations of the method 700 can be implemented in various orders or sequences. In addition, in some examples, the method 700 can also include fewer or additional operations.

FIG. 8 depicts an example of a neonate care station configured to operate as an incubator with a closed canopy. The neonate care station 800 can include any number of walls 802, a support platform 804, and a canopy 806. The canopy 806 and the walls 802 can support or define a microenvironment 808 for a neonate patient residing within the neonate care station 800. A modulating heater 810 can be located or reside within a fixed or dynamic location in relation to the support platform 804. For example, the modulating heater 810 can be located within any suitable housing 812 proximate to the support platform 804.

In some examples, one or more fans 813 can provide, emit, or otherwise circulate thermally conditioned air along the top of the microenvironment 808 proximate to the inside of the canopy 806. The one or more fans 813 can also be configured to circulate thermally conditioned air along any number of the walls 802 of the neonate care station 800, or the one or more fans 813 can be configured to circulate thermally conditioned air along a combination of an inside of a canopy 806 and one or more walls 802. In some examples, the fans 813 can be located proximate to the modulating heater 810 to use the heater element and reflective dish of the modulating heater 810 as a heat source. The fans 813 can draw air over or through the modulating heater 810 to heat up the microenvironment 808 of the neonate care station 800, thus providing thermally conditioned air in the incubator mode along the canopy 806 or the walls 802.

In some examples, the one or more fans 813 can be located proximate to the modulating heater 810, coupled to the modulating heater 810, or located at any suitable location proximate to the microenvironment 808 to enable circulating thermally conditioned air along the top of the canopy 806 in a closed position. In some examples, the fans 813 can stop or alter the speed at which the thermally conditioned air is circulated in the microenvironment 808 in response to the canopy 806 opening to operate as a radiant warmer. In some examples, the fans 813 can stop or alter the speed at which the thermally conditioned air is circulated in the microenvironment 808 in response to any suitable modifications or changes to setpoints in closed bed mode. A setpoint, as referred to herein, can include an expected or desired value for a temperature of the air in the microenvironment, the body temperature of the infant at various points on the body, humidity, and oxygen levels, among others.

It is to be understood that the block diagram of FIG. 8 is not intended to indicate that the neonate care station 800 is to include all of the components shown in FIG. 8. Rather, the neonate care station 800 can include fewer or additional components not illustrated in FIG. 8 (e.g., additional walls, porthole access points, display panels, or drawers, etc.).

FIG. 9 is a block diagram of an example of a computing device that can operate a modulating heater in a neonate care station. The computing device 900 may be, for example, a neonate care station, a laptop computer, a desktop computer, a tablet computer, or a mobile phone, among others. The computing device 900 may include a processor 902 that is adapted to execute stored instructions, as well as a memory device 904 that stores instructions that are executable by the processor 902. The processor 902 can be a single core processor, a multi-core processor, a computing cluster, or any number of other configurations. The memory device 904 can include random access memory, read only memory, flash memory, or any other suitable memory systems. The instructions that are executed by the processor 902 may be used to implement a method that can operate a modulating heater in a neonate care station, as described in greater detail above in relation to FIGS. 3-8.

The processor 902 may also be linked through the system interconnect 906 (e.g., PCI, PCI-Express, NuBus, etc.) to a display interface 908 adapted to connect the computing device 900 to a display device 910. The display device 910 may include a display screen that is a built-in component of the computing device 900. The display device 910 may also include a computer monitor, television, or projector, among others, that is externally connected to the computing device 900. The display device 910 can include light emitting diodes (LEDs), and micro-LEDs, Organic light emitting diode OLED displays, among others.

The processor 902 may be connected through a system interconnect 906 to an input/output (I/O) device interface 912 adapted to connect the computing device 900 to one or more I/O devices 914 The I/O devices 914 may include, for example, a keyboard and a pointing device, wherein the pointing device may include a touchpad or a touchscreen, among others. The I/O devices 914 may be built-in components of the computing device 900 or may be devices that are externally connected to the computing device 900.

In some embodiments, the processor 902 may also be linked through the system interconnect 906 to a storage device 916 that can include a hard drive, an optical drive, a USB flash drive, an array of drives, or any combinations thereof. In some embodiments, the storage device 916 can include any suitable applications. In some embodiments, the storage device 916 can include a heater manager 918. In some embodiments, the heater manager 918 can detect an incubator setting for a neonate care station and provide thermally conditioned air to a support platform or mattress of the neonate care station. The heater manager 918 can also detect a reconfiguration of the neonate care station from an incubator with a closed canopy to a warmer with an open canopy and reposition the modulating heater to provide radiant heat towards the top of the neonate care station. In some examples, the heater manager 918 can also provide radiant heat to the support platform of the neonate care station with radiant heat being projected from an overhead reflective dish.

In some examples, the heater manager 918 can also detect a warmer setting for a neonate care station and provide radiant heat to a support platform or mattress of the neonate care station. The heater manager 918 can detect a reconfiguration of the neonate care station from a warmer with an open canopy to an incubator with a closed canopy and reposition the modulating heater to provide thermally conditioned air towards the bottom of the neonate care station. The heater manager 918 can also provide air to the support platform of the neonate care station with thermally conditioned air projected from a heat sink and any suitable ducts below or proximate to a support platform of the neonate care station.

In some examples, a network interface controller (also referred to herein as a NIC) 920 may be adapted to connect the computing device 900 through the system interconnect 906 to a network 922. The network 922 may be a cellular network, a radio network, a wide area network (WAN), a local area network (LAN), or the Internet, among others. The network 922 can enable data, such as alerts, among other data, to be transmitted from the computing device 900 to remote computing devices, remote display devices, and the like. In some examples, the heater manager 918 can transmit, using the NIC 920 and the network 922, an alert to any suitable external device such as a mobile device, a computing device, or a device in a hospital setting, among others.

It is to be understood that the block diagram of FIG. 9 is not intended to indicate that the computing device 900 is to include all of the components shown in FIG. 9. Rather, the computing device 900 can include fewer or additional components not illustrated in FIG. 9 (e.g., additional memory components, embedded controllers, additional modules, additional network interfaces, etc.). Furthermore, any of the functionalities of the heater manager 918 may be partially, or entirely, implemented in hardware and/or in the processor 902. For example, the functionality may be implemented with an application specific integrated circuit, logic implemented in an embedded controller, or in logic implemented in the processor 902, among others. In some embodiments, the functionalities of the heater manager 918 can be implemented with logic, wherein the logic, as referred to herein, can include any suitable hardware (e.g., a processor, among others), software (e.g., an application, among others), firmware, or any suitable combination of hardware, software, and firmware.

FIG. 10 is an example of a non-transitory machine-readable medium for heating a neonate care station with a modulating heater, in accordance with examples. The non-transitory, machine-readable medium 1000 can implement the functionalities of the heater manager 918 of FIG. 9, among others. For example, a processor 1002 can access the non-transitory, machine-readable media 1000.

In some examples, the non-transitory, machine-readable medium 1000 can include instructions to execute a heater manager 918. For example, the non-transitory, machine-readable medium 1000 can include instructions for the heater manager 918 that cause the processor 1002 to detect an incubator setting for a neonate care station and provide thermally conditioned air to a support platform or mattress of the neonate care station. The non-transitory, machine-readable medium 1000 can also include instructions for the heater manager 918 that cause the processor 1002 to detect a reconfiguration of the neonate care station from an incubator with a closed canopy to a warmer with an open canopy and reposition the modulating heater to provide radiant heat towards the top of the neonate care station. In some examples, the non-transitory, machine-readable medium 1000 can include instructions for the heater manager 918 that cause the processor 1002 to provide radiant heat to the support platform of the neonate care station with radiant heat being projected from an overhead reflective dish.

In some examples, the non-transitory, machine-readable medium 1000 can include instructions for the heater manager 918 that cause the processor 1002 to detect a warmer setting for a neonate care station and provide radiant heat to a support platform or mattress of the neonate care station. The non-transitory, machine-readable medium 1000 can include instructions for the heater manager 918 that cause the processor 1002 to detect a reconfiguration of the neonate care station from a warmer with an open canopy to an incubator with a closed canopy and reposition the modulating heater to provide thermally conditioned air towards the bottom of the neonate care station. The non-transitory, machine-readable medium 1000 can include instructions for the heater manager 918 that cause the processor 1002 to provide air to the support platform of the neonate care station with thermally conditioned air projected from a heat sink and any suitable ducts below or proximate to a support platform of the neonate care station.

In some examples, the non-transitory, machine-readable medium 1000 can include instructions to implement any combination of the techniques of the heater manager 918 described above.

FIG. 11 is an example process flow diagram for operating a neonate care station without a heat sink. In some examples, the method 1100 can be implemented with any suitable device such as the neonate care station 600 of FIG. 6 or 800 of FIG. 8, among others.

At block 1102, the method 1100 includes providing radiant heat with a modulating heater in a warmer mode of a neonate care station. In some examples, the modulating heater can include a heater element and a reflective dish that directly provide radiant heat to a support platform, bed, mattress, or the like of a neonate care station.

At block 1104, the method 1100 includes detecting a canopy closure of a neonate care station. In some examples, the canopy closure indicates that a canopy has been lowered to the walls of the neonate care station to operate as an incubator.

At 1106, the method 1100 includes switching orientation of a reflective dish of the modulating heater. For example, the orientation of the reflective dish of the modulating heater can be switched from an angle to provide radiant heat to the support platform to an angle such that radiant heat is not incident on the support platform. The heater power and operating condition can be adjusted such that the heater element and reflective dish of the modulating heater act as a heat source. As discussed below in relation to block 1110, fans can draw/push air over or through the modulating heater to provide thermally conditioned air.

At block 1108, the method 1100 includes adjusting a power level of a heater element of the modulating heater. In some examples, the power level can be adjusted to any suitable power level so that the heater element in combination with the fans provide thermally conditioned air with the expected or desired temperature.

At block 1110, the method 1100 includes providing power to fans of the neonate care station to provide thermally conditioned air along the canopy or walls of the neonate care station. In some examples, any number of fans can be located proximate to the modulating heater to use the heater element and reflective dish of the modulating heater as a heat source. The fans can draw air over or through the modulating heater to heat up the microenvironment of the neonate care station, thus providing thermally conditioned air in the incubator mode along the canopy or the walls.

The process flow diagram of method 1100 of FIG. 11 is not intended to indicate that all of the operations of blocks 1102-1110 of the method 1100 are to be included in every example. Additionally, the process flow diagram of method 1100 of FIG. 11 describes a possible order of executing operations. However, it is to be understood that the operations of the method 1100 can be implemented in various orders or sequences. In addition, in some examples, the method 1100 can also include fewer or additional operations.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described embodiments can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

What is claimed is:

1. A neonate care station comprising:
a support platform for a neonate;
a modulating heater comprising a heater element coupled to a first reflective dish, wherein the heater element and the first reflective dish are configured to modulate to provide thermally conditioned air to the support platform using a convective heating technique in an incubator setting or radiant heat using a radiant heating technique in a radiant heating setting.

2. The neonate care station of claim 1, wherein the heater element is located at a static position proximate to the support platform.

3. The neonate care station of claim 1, wherein the heater element and the first reflective dish of the modulating heater is configured to dynamically reposition to provide radiant heat to a heat sink proximate to the support platform.

4. The neonate care station of claim 1, wherein the heater element is configured to dynamically reposition to provide the thermally conditioned air along a canopy or a side wall of the neonate care station.

5. The neonate care station of claim 1, wherein a reflective channel focuses the radiant heat from the heater element and the first reflective dish to a second reflective dish located higher than the support platform, the second reflective dish to provide a heat pattern to the support platform.

6. The neonate care station of claim 1, wherein one or more fans are located in a canopy of the neonate care station, the one or more fans to circulate the thermally conditioned air, using the convective heating technique, from the heater element in response to the canopy being affixed to one or more walls of the neonate care station.

7. The neonate care station of claim 1, wherein the heater element is configured to modulate a predetermined number of degrees from a downward facing position providing the radiant heat onto a heat sink to warm a microenvironment using the convective heating technique to an upward facing position providing the radiant heat to a second reflective dish that distributes the radiant heat to the support platform using the radiant heating technique.

8. The neonate care station of claim 1, wherein the modulating heater is coupled to a canopy of the neonate care station, and wherein the modulating heater is configured to modulate from a first position providing the thermally conditioned air using the convective heating technique in a closed canopy setting to a second position providing the radiant heat to a second reflective dish that distributes the radiant heat to the support platform using the radiant heating technique in an open canopy setting.

9. The neonate care station of claim 8, wherein continuous power is provided to the modulating heater during a transition from the first position to the second position.

10. The neonate care station of claim 9, wherein a heating output of the modulating heater is modified as the modulating heater transitions from the first position to the second position.

11. The neonate care station of claim 1, wherein the heater element is configured to dynamically reposition to focus on a phase change material proximate to a bed.

12. The neonate care station of claim 1, wherein the heater element of the modulating heater is configured to connectively couple with a heat sink through one or more openings of the heat sink.

13. A method for operating a neonate care station comprising:
detecting an incubator setting for the neonate care station;
providing, using a modulating heater, thermally conditioned air to a support platform of the neonate care station;
detecting a reconfiguration of the neonate care station from an incubator with a closed canopy to a neonate warmer with an open canopy;
repositioning the modulating heater to provide radiant heat towards a top of the neonate care station; and
providing the radiant heat to the support platform of the neonate care station using the modulating heater and an overhead reflective dish.

14. The method of claim 13, wherein the modulating heater is located at a static position proximate to the support platform.

15. The method of claim 13, wherein a heater element of the modulating heater is configured to dynamically reposition to provide, using one or more fans, the thermally conditioned air proximate to the support platform.

16. The method of claim 13, wherein a heater element is configured to dynamically reposition to provide, using one or more fans, the thermally conditioned air along a canopy or a side wall of the neonate care station.

17. The method of claim 13, wherein a reflective channel focuses the radiant heat from a heater element and a first reflective dish to a second reflective dish located higher than the support platform, the second reflective dish to provide a heat pattern to the support platform.

18. The method of claim 13, wherein a reflective channel focuses the radiant heat from a heater element and a first reflective dish to a second reflective dish located higher than the support platform, the second reflective dish to provide a heat pattern to the support platform.

19. A method for operating a neonate care station comprising:
detecting a warmer setting for the neonate care station;
providing, using a modulating heater, radiant heat to a support platform of the neonate care station;
detecting a reconfiguration of the neonate care station from a neonate warmer with an open canopy to an incubator with a closed canopy; and
providing thermally conditioned air to the support platform of the neonate care station using the modulating heater and one or more fans to support a convective heating of a microenvironment of the neonate care station.

20. The method of claim 19, wherein the modulating heater is located at a static position or a dynamic position proximate to the support platform.
